(19) United States
(12) Patent Application Publication
(10) Pub. No.: US 2010/0259107 A1
(43) Pub. Date: Oct. 14, 2010

(54) Systems and Methods for Providing Power to a Device Under Test

(76) Inventors: Peter Kinget, Summit, NJ (US); Jean-Olivier Plouchart, New York, NY (US)

Correspondence Address: Byrne Poh LLP, 11 Broadway, Ste 865, New York, NY, 10004, US

(21) Appl. No.: 12/679,204

(22) PCT Filed: Nov. 14, 2008
(86) PCT No.: PCT/US08/83642

§ 371 Date: Mar. 19, 2010

Related U.S. Application Data
(60) Provisional application No. 60/987,860, filed on Nov. 14, 2007.

(51) Int. Cl. H02J 17/00

(52) U.S. Cl. 307/104

(57) ABSTRACT

Systems and methods for providing power to a device under test are prcn ided. In some embodiments, systems for providing power to a device under test are provided, the systems comprising a power source for providing an alternating current, a probe having a probe inductor coupled to the power source; and a device under test having a device inductor magnetically coupled to the probe inductor, and having a circuit to be tested that receives power produced in the device inductor, In some embodiments, devices that receive power from a probe having an inductor that is coupled to an alternating current power source are provided, the devices comprising: a device inductor magnetically coupled to the probe inductor; and a circuit to be tested that receives power produced in the device inductor.

### CROSS REFERENCE TO RELATED APPLICATION

This application claims the benefit of U.S. Provisional Patent Application No. 60/987,860, filed Nov. 14, 2007, which is hereby incorporated by reference herein in its entirety.

### TECHNICAL FIELD

The disclosed subject matter relates to systems and methods for providing power to a device under test.

### BACKGROUND

The manufacturing of electronic components is a complicated, multi-step process. Frequently, during the manufacturing process, it is desirable to be able to test an electronic component to confirm that the component works correctly before continuing on with the manufacturing process. In this way, out-of-specification components or defective components can be detected early and subsequent manufacturing steps can be adjusted or skipped—thereby saving money and reducing the subsequent cost of final products.

In order to test an electronic component during manufacturing (on a silicon wafer, for example), it is necessary to deliver power to the component. However, existing testing approaches to delivering power to electronic components which do so by making electrical and physical contact with the components are risky because the electronic components may be damaged due to physical contact (e.g., scratches), electro-static discharge (ESD), contamination, etc.

### SUMMARY

Systems and methods for providing power to a device under test are provided. In some embodiments, systems for providing power to a device under test are provided, the systems comprising: a power source for providing an alternating current; a probe having a probe inductor coupled to the power source; and a device under test having a device inductor magnetically coupled to the probe inductor, and having a circuit to be tested that receives power produced in the device inductor.

In some embodiments, devices that receive power from a probe having an inductor that is coupled to an alternating current power source are provided, the devices comprising: a device inductor magnetically coupled to the probe inductor; and a circuit to be tested that receives power produced in the device inductor.

In some embodiments, methods for providing power to a device under test are provided, the methods comprising: providing an alternating current; coupling a probe inductor to the alternating current; magnetically coupling a device inductor to the probe inductor to produce power; and providing the produced power to a circuit under test.

### BRIEF DESCRIPTION OF THE DRAWINGS

FIG. 1 is a side-view diagram of a mechanism for delivering power to a device under test in accordance with some embodiments.

FIG. 2 is a top-view diagram of a mechanism for delivering power to a device under test in accordance with some embodiments.

FIG. 3 is schematic of a circuit for delivering power to device under test in accordance with some embodiments.

FIG. 4 is a perspective-view of inductors for delivering, power to a device under test in accordance with some embodiments.

FIG. 5 is a top-view diagram of an inductor for delivering power to a device under test in accordance with some embodiments.

FIG. 6 is a cross-section-view diagram of a probe for delivering power to a device under test in accordance with some embodiments.

FIG. 7 is a top-view diagram of a mask for forming a probe for delivering power to a device under test in accordance with some embodiments.

FIG. 8 is a schematic diagram of a rectifier for delivering power to a device under test in accordance with some embodiments.

FIG. 9 is a schematic diagram of a regulator and reference for delivering power to a device under test in accordance with some embodiments.

FIG. 10 is a layout diagram of a device under test that includes an inductor, a rectifier, and a regulator for receiving power in accordance with some embodiments.

### DETAILED DESCRIPTION

In accordance with various embodiments, systems and methods for providing power to a device under test are provided. These systems and methods can be used in a variety of applications. For example, these systems and methods can be used to provide power to a silicon wafer containing electronic circuits for testing during various stages of the silicon wafer manufacturing process. In some embodiments, power can be provided to such a silicon wafer without the power source physically touching the silicon wafer. By avoiding touching the silicon wafer, the risk of scratches, electro-static discharge (ESD) damage, contamination, and/or other damage that may occur to the silicon wafer can be reduced. In some embodiments, power can be delivered to a silicon wafer using a soft and/or flexible probe that similarly does not damage the surface of the silicon wafer even though it may touch the wafer. While various embodiments are described herein that provide power to silicon wafers, it should be apparent that power delivery can be provided in accordance with sonic embodiments to any other suitable devices, such as devices on wafers other than silicon wafers, devices in non-wafer manufacturing processes, etc. For example, power can be provided to devices on wafers such as those based on silicon-on-insulator, silicon-on-sapphire, gallium arsenide, indium-phosphide, and/or any other suitable semiconductor technology used for chip design.

In some embodiments, systems and methods can provide power to a device through a magnetic coupling between a probe that provides the power and a device that receives the power. This magnetic coupling can be implemented by driving a probe inductor on the probe with an alternating current (e.g., such as a GHz signal) and placing the probe inductor near an inductor on the device. The device inductor can then produce a current that can be rectified and regulated by circuitry on the device to drive one or more other circuits on the device.

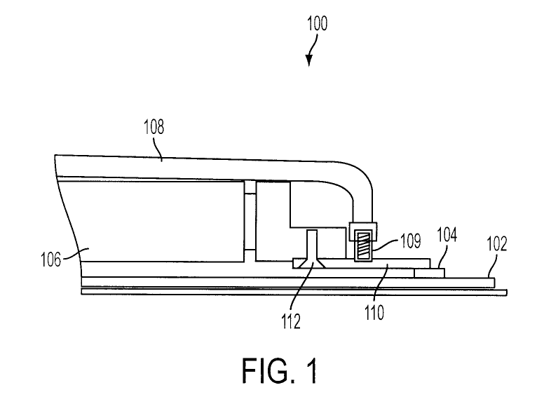

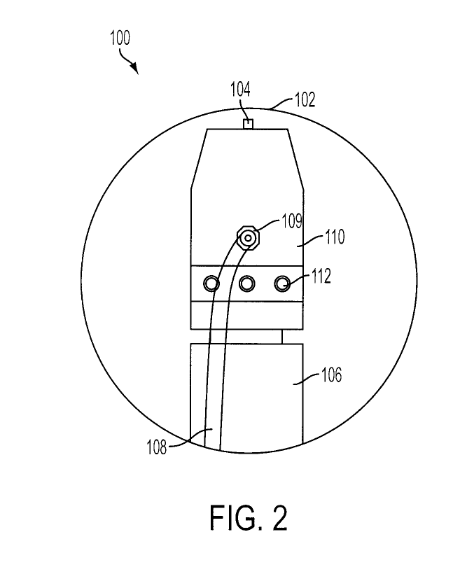

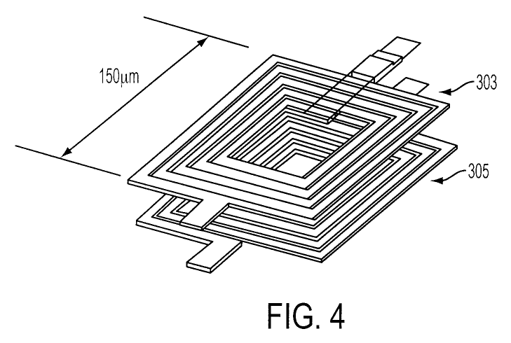

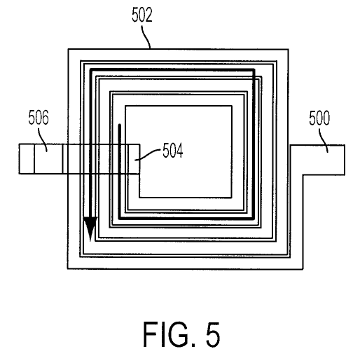

Turning to FIGS. 1 and 2, side and top views of a mechanism 100 for delivering power to a device under test 102 in accordance with some embodiments are shown. As illustrated, this mechanism includes a probe 104 coupled to a micro-positioner 106. In some embodiments, probe 104 can be coupled to micro-positioner 106 using a printed circuit board (PCB) 110. As illustrated, the PC 13 can be connected to the micro-positioner using one or more suitable screws 112 or any other suitable mechanism, and the probe can be coupled to the PCB using isotropic conducting contact adhesive or any other suitable mechanism. The PCB can include any suitable conductors for connecting the probe to a power source 108 (which can be a cable (shown) coupled to an alternating current signal source (not shown), such as a signal generator that produces signals with a GHz frequency available from companies such as Agilent Technologies, Inc.). For example, in some embodiments, these conductors can include microstrip on the bottom of the PCB, a ground plane on the top of the PCB, and an SMA connector 109 (or any other suitable connector) coupling the microstrip and the ground plane to power source 108. Because the signal provided via power source 108 can be a 1-100 GHz signal (or a signal having any other suitable frequency) in some embodiments, using microstrip, a. ground plane, and an SMA connector on the PCB can maintain the integrity of the signal as it reaches the probe. In some embodiments, the probe can include a spiral inductor (for example, as illustrated in FIGS. 4 and 5) mounted on the top of the probe and electrically connected to the microstrip and the ground plane of the PCB.

Although FIGS. 1 and 2 describe a probe as having a glass substrate, in accordance with some embodiments, a probe can be implemented with an inductor attached to a soft and/or flexible substrate. For example, in some embodiments a probe substrate can be made of polyethylene naphthalate (PEN). By using, a soft and/or flexible substrate, in some embodiments, the substrate can be placed against a device, under test (such as a silicon wafer) with a reduced risk of scratching or otherwise damaging the surface of the device under test.

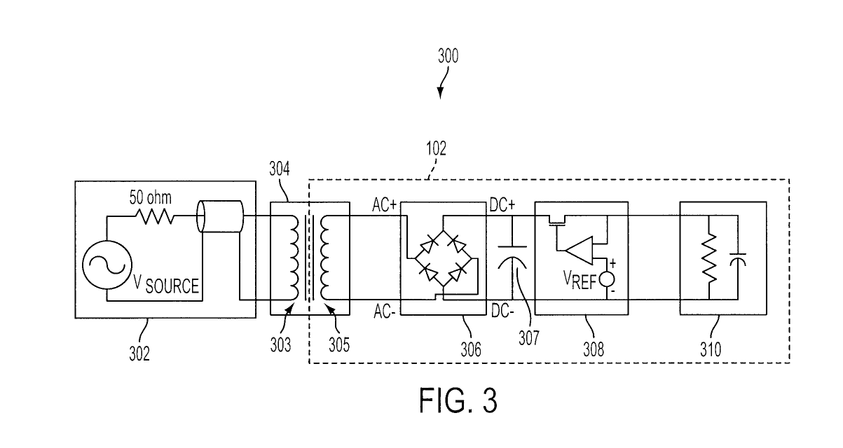

As illustrated in FIG. 3, in accordance with some embodiments, power can be delivered from a power source 302 to a device under test 102 by forming a transformer 304 using an inductor 303 on the probe in close proximity to an inductor 305 on the device under test. Power source 302 can be any suitable power source, and, in some embodiments, can output a 16 dBm (or any other suitable power) sinusoid having a 2.6-2.7 GHz frequency (or any other suitable frequency—e.g., 1-100 GHz). Power from power source 302 will thus be coupled from inductor $03 to inductor 305 and then provided to rectifier 306, which can include one or more rectifier capacitors 307 in some embodiments. After rectification by rectifier 306, the power will then be provided to a regulator and reference 308. Finally, after being regulated, the power can be provided to a load circuit 310, which is illustrated in FIG. 3 as a model of a load of a device under test. Load circuit 310 can be an suitable active or passive device under test, or combination of devices in a circuit or system under test. In some embodiments, such a configuration can be capable of producing 1 VDC and 8.51 mW of power to the load circuit.

FIG. 4 illustrates examples of shapes and a relative positioning of inductors 303 and 305 in accordance with some embodiments. As can be seen, these inductors can be implemented as spiral inductors in some embodiments. Such spiral inductors can be implemented using known photolithography, printed circuit board, and semiconductor wafer manufacturing techniques. In some embodiments, inductor 303 can be implemented with a wire spacing of 0.84 μm, a wire thickness of 10.3 μm, and three turns, and inductor 305 can be implemented with a wire spacing of 0.92 μm, a wire thickness of 6.0 μm, and five turns. FIG. 5 shows an example of current flow at an instant in time through a spiral inductor (which can be inductor 303 or inductor 305) in accordance with some embodiments. As can be seen, the current is looping through the spiral 502 from a center via 504 outward to terminal 500. At other instances in time, the current can loop in the opposite direction i.e., from terminal 500 toward center via 504. In order to connect the inductor to a power source (when inductor 303) or a rectifier (when inductor 305), an overpass or underpass can be used to connect via 504 to via 506. As shown, the overpass or underpass passes around the paths of 502 forming the spiral inductor.

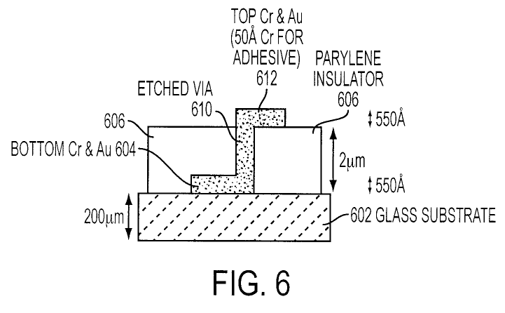

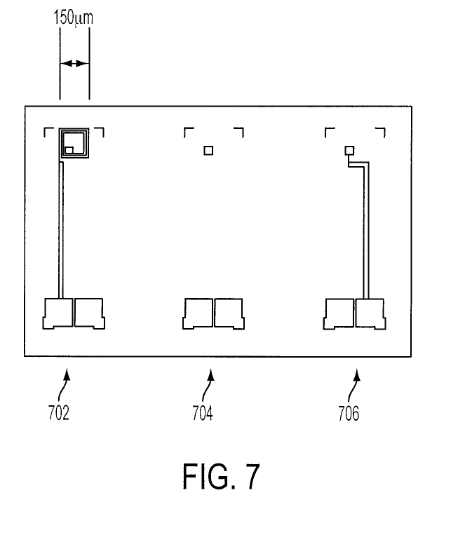

FIG. 6 illustrates a cross section of layers of materials that can be used to manufacture a probe in accordance with some embodiments. As shown, the probe can be implemented in some embodiments on a 200 μm (or any other suitable thickness) glass (or any other suitable material) substrate 602. As shown, a layer 604 of chrome-gold (Cr and Au) (or any other suitable material) can be used to for the spiral of the probe inductor. Layer 604 can be 550 angstroms thick (or any other suitable thickness). A parylene insulator (or any other suitable material) layer 606 can be formed around layer 604 to a depth of 2 μm (or any other suitable thickness). A via 610 can then be etched in layer 606 and filled with chrome-gold (Cr and Au) (or any other suitable material). A 550 angstrom thick (of any other suitable thickness) overpass 612 can then be formed on top of parylene layer 606. FIG. 7 shows an example of three photolithography masks that can be used to implement a probe in some embodiments. As illustrated, portion 702 can be used to form the spiral for the inductor, portion 704 can be used to form the via for the inductor, and portion 706 can be used to form an overpass for the inductor. As also illustrated, in some embodiments, the inductor may have an outside dimension of 150 μm.

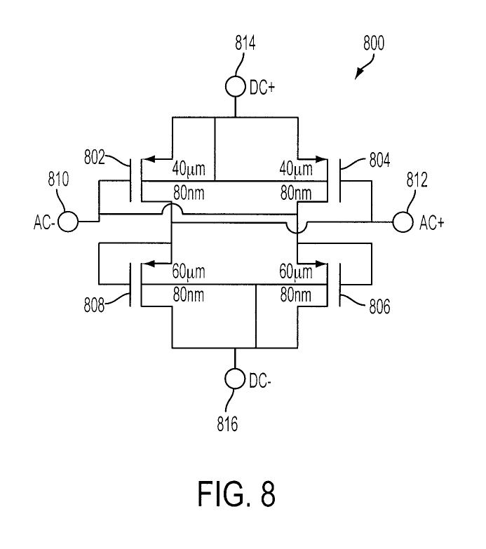

As described above, a rectifier (such as rectifier 306 of FIG. 3) can be used to rectify power coupled from the probe inductor to the device-under-test inductor. This rectifier can be a bridge rectifier (or any other suitable rectifier architecture) in some embodiments. As illustrated in FIG, 8, such a bridge rectifier can be formed from four low-V_{T}, p-channel, metal-oxide-semiconductor (PMOS), diode-connected field effect transistors (FETs) 802, 804, 806, and 808 connected as shown. AC terminals 810 and 812 can be connected to the inductor on the device under test. DC terminal 814 and 816 can then be connected to a regulator and reference circuit, such as regulator and reference circuit 308 in FIG. 3. In some embodiments, transistors 802 and 804 can have widths of 40 μm and lengths of 80 nm when realized in a 90 nm CMOS process, and transistors 806 and 808 can have widths of 60 μm and lengths of 80 nm when realized in a 90 nm CMOS process. Although only a single bridge rectifier is shown in FIG. 8, in some embodiments, multiple (e.g., six) bridge rectifiers of the same or different designs) can be connected in parallel to implement a rectifier.

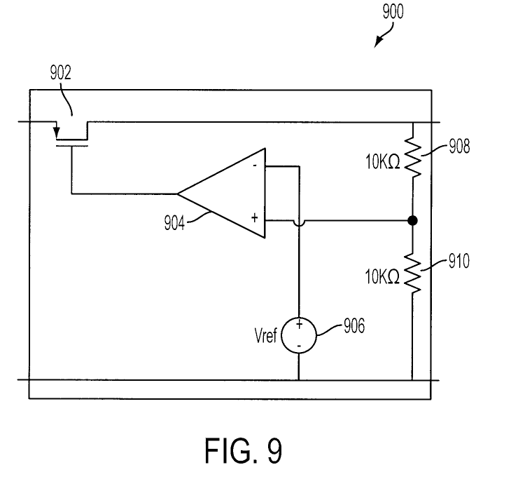

As also described above, a regulator and a reference (such as that in regulator and reference 308 of FIG. 3) can be used to regulate the power provided to a load circuit after being rectified. In some embodiments, such a regulator and reference 900 can be implemented using a power transistor 902, an operational trans-conductance amplifier 904, a voltage reference 906 configured, and resistors 908 and 910 as illustrated in FIG. 9. Power transistor 902 is illustrated as being a PMOS transistor, however, in some embodiments, an NMOS transistor can be used instead when the inputs to amplifier 904 are swapped. In some embodiments, operational trans-conductance amplifier 904 can be a single stage design biased in deep weak-inversion to minimize power consumption, and in some embodiments, operation trans-conductance amplifier 904 can be replace with an operational amplifier. Voltage reference 906 can be a bandgap reference implemented as described in H. Banba et al., “A CMOS Baa Reference Circuit with sub-1-V Operation,” IEEE Journal of Solid State Circuits, 35:670-674, May 1999, which is hereby incorporated by reference herein in its entirety, in some embodiments. Resistors 908 and 910 are shown as being 10 k ohm resistors, however any suitable values of resistors can be used in some embodiments. Although one particular form of regulator and reference voltage is illustrated in FIG. 9, any suitable regulator and reference voltage circuitry can be used in some embodiments.

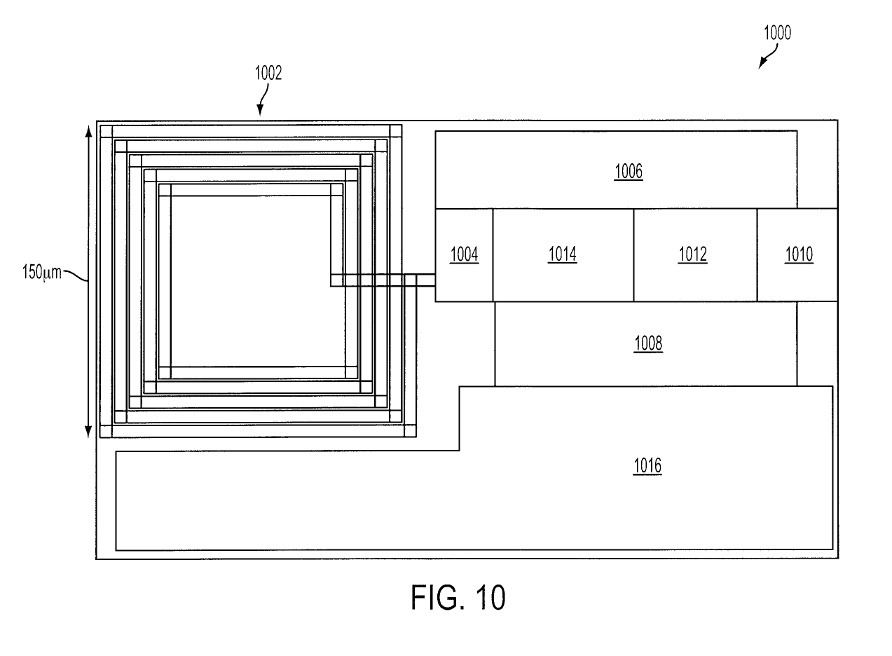

FIG. 10 illustrates an example of a layout 1000 that can be used on a device under test in accordance with some embodiments. As shown, layout 1000 provides a region 1002 for a spiral inductor on the device under test. This inductor can have outside dimensions of 150 μm (or any other suitable dimensions) on each side. A rectifier can be implemented in a rectifier region 1004 in layout 1000 next to the inductor. Rectifier capacitors can be implemented in rectifier capacitor regions 1006 and 1008. A power transistor and an operational trans-conductance amplifier can be implemented in a regulator region 1010. A voltage reference can be implemented in a reference region 1012 and a reference diodes region 1014. And any suitable load can be implemented in a load region 1016. As can be seen, region 1002 includes an empty interior space in which some portions of the rectifier and/or regulator circuits can be located. Additionally or alternatively, in some embodiments, the rectifier and/or regulator and reference circuits can be located underneath the inductor in region 1002, for example using techniques such as that describe in United States Patent Publication No. US 2008/0180187 A1 (published Jul. 31, 2008) and in Zhang and Kinget, “Design of Components and Circuits Underneath Integrated Inductors,” IEEE Journal of Solid State Circuits, Vol. 41, Issue 10, Oct. 2006, pp. 2265-2271, each of which is hereby incorporated by reference herein in their entireties. In some embodiments, the regions corresponding to the inductor, rectifier, and regulator can be implemented in space reserved for silicon wafer slicing, in some embodiments, this layout can be implemented in 90 nm CMOS technologies.

In some embodiments, in addition to providing power through the magnetic coupling described above, input and output signals to/from the circuit under test can also be conveyed through the magnetic coupling using any suitable technique—such as modulating the power signal.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A system for providing power to a device under test, comprising:
a power source for providing an alternating current;
a probe having a probe inductor coupled to the power source; and
a device under test having a device inductor magnetically coupled to the probe inductor, and having a circuit to be tested that receives power produced in the device inductor.

2. The system of claim 1, wherein the device under test also has a rectifier having an input coupled to the device inductor, has a voltage reference, and has a regulator having inputs coupled to an output of the rectifier and the voltage reference and having an output coupled to the circuit to be tested.

3. The system of claim 1, wherein the alternating current has a frequency of 1-100 GHz.

4. The system of claim 1, wherein the probe has a glass substrate.

5. The system of claim 1, wherein the probe has a soft and/or flexible substrate.

6. The system of claim 1, wherein the probe inductor is a spiral inductor.

7. The system of claim 1, wherein the probe inductor is about 150 μm in diameter.

8. The system of claim 1, wherein the probe inductor has a diameter between 10 μm and 1000 μm.

9. The system of claim 1, wherein the device under test is a wafer for an electronic component.

10. The system of claim 9, wherein the wafer is a silicon wafer.

11. The system of claim 1, wherein the device inductor is a spiral inductor.

12. The system of claim 1, wherein the device inductor is about 150 μm in diameter.

13. The system of claim 1, wherein the probe is physically separated from the device under test.

14. The system of claim 1, wherein the probe is physically contacting the device under test.

15. The system of claim 1, wherein the probe is flexible.

16. A device that receives power from a probe having an inductor that is coupled to an alternating current power source, comprising:
a device inductor magnetically coupled to the probe inductor; and
a circuit to be tested that receives power produced in the device inductor.

17. The device of claim 16, wherein the device further comprises:
a rectifier having an input coupled to the device inductor;
a voltage reference; and
a regulator having inputs coupled to an output of the rectifier and the voltage reference and having an output coupled to the circuit to be tested.

18. The device of claim 16, wherein the alternating current power source has a frequency of 1-100 GHz.

19. The device of claim 16, wherein the device is a wafer for an electronic component.

20. The device of claim 19, wherein the wafer is a silicon wafer.

21. The device of claim 16, wherein the device inductor is a spiral inductor.

22. The device of claim 16, wherein trite device inductor is about 150 μm in diameter.

23. A method for providing power to a device under test, comprising:
providing an alternating current;
coupling a probe inductor to the alternating current;
magnetically coupling a device inductor to the probe inductor to produce power; and
providing the produced power to a circuit under test.

24. The method of claim 23, further comprising:
rectifying an output of the device inductor to produce a rectified output;
producing a reference voltage; and
regulating the rectified output to produce as regulated output with respect to the reference voltage,
wherein the produced power is provided to the circuit under test as the regulated output.

25. The method of claim 23 ,wherein the alternating current has a frequency of 1-100 GHz.

26. The method of claim 23, wherein the probe inductor is a spiral inductor.

27. The method of claim 23, wherein the probe inductor is about 150 μm in diameter.

28. The method of claim 23, wherein the probe inductor has a diameter between 10 μm and 1000 μm.

29. The method of claim 23, wherein the device under test is a wafer for an electronic component.

30. The method of claim 29, wherein the wafer is a silicon wafer.

31. The method of claim 23, wherein the device inductor is a spiral inductor.

32. The method of claim 23, wherein the device inductor is about 150 μm in diameter.
